(19) United States
(12) Patent Application Publication
(10) Pub. No.: US 2013/0064751 A1
(43) Pub. Date: Mar. 14, 2013

(54) METHOD FOR PRODUCING HIGH PURITY SILICON

(71) Applicants: Jochem Hahn, Rottenburg (DE); Uwe Kerat, Baiersbronn (DE); Christian Schmid, Freudenstadt (DE)

(72) Inventors: Jochem Hahn, Rottenburg (DE); Uwe Kerat, Baiersbronn (DE); Christian Schmid, Freudenstadt (DE)

(73) Assignee: SCHMID SILICON TECHNOLOGY GMBH, Freudenstadt (DE)

(21) Appl. No.: 13/583,043

(22) PCT Filed: Mar. 9, 2011
(86) PCT No.: PCT/EP11/53504

§ 371 Date: Sep. 18, 2012

(30) Foreign Application Priority Data
Mar. 9, 2010 (DE) 102010011853.2

(51) Int. Cl. C01B 33/02

(52) U.S. Cl. 423/348; 65/66

(57) ABSTRACT

A process of producing high-purity silicon includes providing silicon-containing powder, feeding the silicon-containing powder into a gas stream, where the gas has a temperature sufficiently high to convert particles of metallic silicon from a solid state into a liquid and/or gaseous state, collecting and, optionally, condensing the liquid and/or gaseous silicon formed, and cooling the collected liquid and/or condensed silicon in a casting mold,

### Related Applications

This is a §371 of International Application No. PCT/EP2011/053504, with an international filing date of Mar. 9, 2011 (WO 2011/110577 A1, published Sep. 15, 2011), which is based on German Patent Application No. 10 2010 011 853.2, filed Mar. 9, 2010, the subject matter of which is incorporated by reference.

### TECHNICAL FIELD

This disclosure relates to a process for producing high-purity silicon and also silicon produced by the process.

### BACKGROUND

The term “wafers” refers to thin discs or support plates on which electronic, photo-electrical or micromechanical devices are arranged. Such wafers usually consist of polycrystal-line or monocrystalline material, for example, polycrystalline silicon. To produce such wafers, relatively large blocks of an appropriate raw material are usually parted, in particular sawed, into individual slices. Such blocks of material are also referred to as ingots or bricks.

Parting is generally effected by wire saws, in particular by multiple wire saws, which part a block into many wafers at once. To carry out sawing, the blocks are usually arranged on a support plate which is then fastened in a parting or sawing apparatus.

In wire sawing, a thin wire having a diameter in the range from 80 μm to 200 μm is usually used as a tool. This is generally wetted with a suspension comprising a carrier medium and an abrasive medium (also referred to as “cutting particles”) suspended therein, known as “slurry.” Suitable carrier media are, in particular, high-viscosity liquids such as glycol or oil, which owing to their rheological properties prevent rapid sedimentation of the suspended cutting particles. As abrasive media, it is possible to use, in particular, hard material particles composed of diamond, carbides and nitrides (e.g., silicon carbide and cubic boron nitride),

Strictly speaking, the process is not a sawing process when such a slurry is used. When the wire is wetted, only loose adhesion of abrasive medium on the surface of the wire occurs. The process is therefore often referred to as a “parting-lapping” process. At a defined machining speed, the wire together with the adhering cutting particles is drawn through the sawing cut of the block to be sawed apart, with very small particles of material being torn from the block to be sawed apart. The torn-out particles of material become mixed with the abrasive medium (the cutting particles). The resulting mixture of particles of material, cutting particles and carrier media is usually difficult to utilize in an economical fashion. This is because the separation of carrier medium and the fine particles of solid present therein is technically quite complicated because of the high viscosity of the carrier medium. However, clean separation of the solid particles obtained into clearly defined fractions of cutting particles and torn-out particles of material is even more problematic.

This is extremely unsatisfactory from both an ecological and economic point of view. In wire sawing processes, a not inconsiderable part of the blocks to be sawed apart is cut away. These blocks are themselves produced in preceding processes which are very energy-intensive and costly. The losses of material occurring during wire sawing correspondingly effect the total energy and cost balance of wafer production processes in an extremely adverse manner.

For this reason, it is desirable to provide technical solutions which allow the recycling of waste slurries obtained in sawing processes, in particular recycling of the particles originating from the sawed material which are present therein.

### SUMMARY

We provide a process of producing high-purity silicon including providing silicon-containing powder, feeding the silicon-containing powder into a gas stream, where the gas has a temperature sufficiently high to convert particles of metallic silicon from a solid state into a liquid and/or gaseous state, collecting and, optionally, condensing the liquid and/or gaseous silicon formed, and cooling the collected liquid and/or condensed silicon in a casting mold.

We also provide silicon produced by the process.

### DETAILED DESCRIPTION

Our process is employed for the production of silicon, in particular high-purity silicon, i.e., silicon which can be directly processed further in the semiconductor industry, for example, for production of solar cells, and always comprises at least the following steps:
(1) In the usually first step, silicon-containing powder is provided.
(2) In a further step, the silicon-containing powder is fed into a gas stream. It is important here that the gas has a sufficiently high temperature to convert the particles of metallic silicon from the solid state into the liquid and/or gaseous state. Particles of metallic silicon should thus melt, possibly even at least partly or even completely vaporize, as soon as they come into contact with the gas stream.
(3) The liquid silicon is subsequently collected. If the gas stream contains gaseous silicon, this is at least partially condensed beforehand.
(4) The collected liquid silicon is then cooled, preferably in a casting mold so that an ingot or brick is produced again, ideally directly.

Ingots or bricks produced in this way are subjected, preferably without further processing, directly to a wire sawing process again.

In our process, the silicon-containing powders used are particularly preferably powders which are obtained during wire sawing of a silicon block, in particular using saws having bonded cutting particles, i.e., saws in which the cutting particles are bonded firmly to the wire and are thus constituent of the wire. The process can thus directly follow a wire sawing process.

In contrast to the conventional processes described at the outset, wire sawing using saws having bonded cutting particles does not employ suspensions composed of carrier medium and abrasive particles. Instead, the wire sawing is preferably carried out dry or with addition of water which can serve as a cooling medium and can also flush torn-out silicon particles from the sawing cut. The use of other liquids as cooling medium is also possible. The water or the other liquids can contain various process additives, for example, corrosion inhibitors, dispersants, biocides or antistatic additives. Such additives are known to those skilled in the art and are therefore not described further.

Suitable wire saws having bonded cutting particles are known. Thus, for example, DE 699 29 721 describes a wire saw which comprises a metal wire and superabrasive particles fixed to the wire by a hard-soldered metal bond. The abrasive particles are usually at least partly embedded in a metallic matrix. They preferably comprise diamond, cubic boron nitride or a mixture of such particles.

The use of wire saws having bonded cutting particles has the critical advantage that the solid sawing waste formed during wire sawing comprises very predominantly silicon particles. These can at the outside be contaminated with cutting particles or cutting particle fragments which have been broken out from the wire during sawing or else with metallic constituents of the wire or residues of the abovementioned process additives. In contrast to mixtures formed in the wire sawing processes using unbonded cutting particles as described at the outset, the silicon dusts and powders obtained are accordingly very much more suitable for reprocessing. Separating off a high-viscosity carrier medium becomes completely unnecessary. When water is used, this should be at least substantially separated off and the silicon powder obtained should be dried.

The use of silicon powder which is obtained during wire sawing using suspensions composed of carrier medium and abrasive particles is in principle also conceivable. However, purification of a mixture of particles of material, cutting particles and carrier medium formed during wire sawing using a slurry is much more complicated in comparison.

The silicon particles formed during wire sawing often have only very small particle sizes and are very reactive as a result of their correspondingly large specific surface area. They can react, for example, with water which, as mentioned above, can be used as a cooling medium during wire sawing to form silicon dioxide and hydrogen. The silicon-containing powder provided in the usually first step of the process accordingly does not necessarily have to be a powder of purely metallic silicon particles. This powder can comprise a proportion of silicon particles which are at least slightly oxidized on the surface, and may also consist of such particles.

Impurities present in the silicon-containing powder used are preferably at least largely removed before the powder is fed into the gas stream heated to high temperature. Such prepurification can comprise both chemical and mechanical purification steps.

The chemical purification of the silicon-containing powder serves mainly to remove any metallic impurities present and optionally to remove an oxide layer on the surface. For this purpose, the silicon powder can be treated, for example, with acids or alkalis. Suitable treatment agents include organic acids and also, for example, hydrochloric acid, hydrofluoric acid, nitric acid or a combination of these acids, in particular in dilute form. A suitable procedure is described, for example, in DE 29 33 164. After such a treatment, the silicon generally has to be washed free of acid and dried. Drying can, for example, be carried out with the aid of an inert gas, for example, nitrogen. The drying temperature should preferably be above 100° C. Furthermore, it can be advantageous to carry out drying at a subatmospheric pressure. This too is described in DE 29 23 164. Any acid residues or water residues originating from the chemical treatment can be removed essentially without leaving a residue.

Furthermore, the chemical purification may also serve to remove residues of the abovementioned process additives. These residues can likewise be removed by the abovementioned acids and alkalis. In addition or instead, washing of the collected silicon powder with, for example, an organic solvent or another purifying agent is also conceivable,

Removal of the abovementioned cutting particles or cutting particle fragments from the powder is generally more difficult than removal of metallic impurities. In general, the cutting particles or cutting particle fragments can be removed only by one or more mechanical purification steps.

Since, for example, abrasive hard material particles composed of diamond and cubic boron nitride generally have a significantly higher density than silicon, they can be separated off, for example, by a centrifugal separator. For this purpose, the silicon powder been obtained in a sawing process and has optionally been chemically purified subsequently can, for example, be fractionated according to particle sizes. When the individual fractions are fed into a centrifugal separator, the lighter silicon particles can, at a suitable setting, pass through the separator while heavier hard material particles are precipitated. Essentially, separation of small particles is more complicated than that of larger particles. It can therefore be preferred to discard the fines, i.e., the fractions having the smallest particles, after the abovementioned fractionation and feed only the fractions having the coarser particles into the centrifugal separator.

As an alternative or in addition, the use of one or more hydrocyclones is also possible for mechanical purification of the collected silicon powder. A hydrocyclone is, as is known, a centrifugal separator for liquid mixtures, in particular for removing solid particles present in suspensions. Methods of separating mixtures which can also be used in the process are described, for example, in DE 198 49 870 and WO 2008/078349.

Furthermore, a magnetic separator can also be used to remove metallic impurities. For example, a mixture of water, surface-oxidized silicon particles and steel particles from the matrix of the wire used which results from a wire sawing process can be passed through a magnetic separator. The silicon particles can pass through this unaffected.

The gas stream used in our process, into which the silicon powder is fed, is generally heated by a plasma generator. A plasma is, as is known, a partially ionized gas which contains an appreciable proportion of free charge carriers such as ions or electrons. A plasma is always obtained by introduction of energy from outside, which can be effected, in particular, by thermal excitation, by radiation excitation or by excitation by electrostatic or electromagnetic fields. In our case, the latter excitation method is particularly preferred. Appropriate plasma generators are commercially available and are not described further.

The gas used for the gas stream is preferably hydrogen. Preferably, the gas can also be an inert gas such as a noble gas or a mixture of hydrogen and such an inert gas, in particular argon. In this case, the inert gas is preferably present in the gas mixture in a proportion of from 1% to 50%.

The use a hydrogen-containing gas stream heated to high temperature, in particular a hydrogen plasma heated to high temperature, has advantages particularly when the silicon-containing powder used has a proportion of silicon particles whose surface has been slightly oxidized. This surface can be reduced in the hydrogen atmosphere to form water. The resulting water can subsequently be removed without problems.

The temperature of the gas is particularly preferably selected so that it is below 3000° C., in particular below 2750° C., in particular below 2500° C. Particular preference is given to temperatures in the range from 1410° C. (the melting point of silicon) to 3000° C., in particular from 1410° C. to 2750° C. Within this range, temperatures of from 1410° C. to 2500° C. are more preferred. These temperatures are sufficiently high to at least melt silicon particles fed into the gas stream. Hard material particles such as particles of boron nitride or of diamond, on the other hand, do not melt at these temperatures. If such particles have not already been separated off in an earlier process step, this is possible at the latest now as a result of the different states of matter of silicon and hard material particles. While liquid silicon can be condensed from the gas stream, any fine solid particles present can be discharged with the gas stream.

Particularly preferably, not only the silicon-containing powder, but also a silicon compound which decomposes thermally at gas temperatures in the ranges mentioned are introduced into the gas stream. A compound of this type is preferably a silicon-hydrogen compound, particularly preferably monosilane (SiH₄). The use of silanes which are liquid at room temperature is in principle also conceivable since these are vaporized at the latest on introduction into the gas stream heated to high temperature.

Production of high-purity silicon by thermal decomposition of a silicon-hydrogen compound is already known. In this context, reference is made, for example, to DE 33 11 650 and EP 0181803. In general, the silicon compound to be decomposed originates from a multistage process and on decomposition leads to silicon having a purity which is so extraordinarily high that it is not absolutely necessary for many applications. Addition of silicon dust from a sawing process, as can preferably be provided, enables the silicon obtained from the silicon compound to be “stretched.” The mixing ratio can basically be set at will, depending on the particular case.

Decomposition of a silicon compound in a gas stream heated to high temperature has already been described in as yet unpublished German Patent Application DE 10 2008 059 408.3. In particular, it is stated there that a reactor into which the gas stream is introduced is advantageously used in the decomposition.

Preferably, use is made of a reactor of this type into which the gas stream into which the silicon-containing powder and, optionally, the silicon compound to be decomposed are fed is introduced. Such a reactor can, in particular, be employed for the abovementioned collection and, if appropriate, condensation of the liquid and/or gaseous silicon. In particular, it is provided to separate the mixture of carrier gas, silicon (liquid and/or gaseous) and possibly gaseous decomposition products formed in our process. After the silicon-containing powder and optionally a silicon compound has/have been fed into the gas stream heated to high temperature, the latter no longer comprises only an appropriate carrier gas, but also further constituents.

The reactor generally comprises a heat-resistant interior. It is generally lined with appropriate high-temperature-resistant materials so that it is not destroyed by the gas stream heated to high temperature. Suitable materials are, for example, linings based on graphite or Si₃N₄. Suitable high-temperature-resistant materials are known to those skilled in the art. The question of conversion of any silicon vapor formed into the liquid phase, in particular, plays a large role within the reactor. The temperature of the interior walls of the reactor is naturally an important factor here and is therefore generally above the melting point and below the boiling point of silicon. The temperature of the walls is preferably kept at a relatively low level (preferably in the range from 1420° C. to 1800° C., in particular from 1500° C. to 1600° C.). The reactor can for this purpose have suitable insulation or heating and/or cooling means.

Liquid silicon should be able to collect at the bottom of the reactor. The bottom of the interior of the reactor can have a conical shape with an outlet at the lowest point to aid discharge of the liquid silicon. Discharge of the liquid silicon should ideally be carried out batchwise or continuously. The reactor therefore preferably has an outlet suitable for this purpose. Furthermore, it is naturally also necessary for the gas introduced into the reactor to be discharged again. An appropriate discharge line for the gas stream should therefore be provided in addition to a feed line for the gas stream.

The gas stream is preferably introduced at relatively high velocities into the reactor to achieve good turbulence within the reactor. A pressure slightly above atmospheric pressure, in particular in the range from 1013 to 2000 mbar, preferably prevails in the reactor.

Preferably, at least a section of the interior of the reactor is essentially cylindrical. The gas stream can be introduced via a channel opening into the interior. The opening of this channel is, in particular, arranged in the upper region of the interior, preferably at the upper end of the essentially cylindrical section.

Particularly preferably, the collected liquid silicon is subjected to a vacuum treatment before being cooled. This enables metallic impurities having a relatively high vapor pressure, in particular impurities such as copper, manganese and chromium, to be removed. When a reactor is used, the vacuum treatment is preferably carried out directly after draining the liquid silicon from the reactor.

Furthermore, subjecting the collected liquid silicon to directional solidification during cooling can be preferred. As regards suitable methods of carrying out this step, reference is made, in particular, to DE 10 2006 027 273 and the abovementioned DE 29 33 164. Preferably, it is possible to employ the procedure described in DE 29 33 164, in which the silicon is transferred to a melting crucible and the entire melting crucible is slowly lowered from a heating zone. Accumulation of impurities occurs in the part of the silicon block produced in this step which solidifies last. This part can be mechanically separated off and can optionally be added to the starting material again.

1. A process of producing high-purity silicon comprising:
providing silicon-containing powder,
feeding the silicon-containing powder into a gas stream, where the gas has a temperature sufficiently high to convert particles of metallic silicon from a solid state into a liquid and/or gaseous state,
collecting and optionally, condensing the liquid and/or gaseous silicon formed, and
cooling the collected liquid and/or condensed silicon in a casting mold.

2. The process according to claim 1, wherein the silicon-containing powder is at least partly powder obtained during wire sawing of a silicon block, using exclusively bonded cutting particles.

3. The process according to claim 1, wherein the silicon-containing powder is subjected to a chemical and/or mechanical purification before being fed into the gas stream.

4. The process according to claim 1, wherein the gas stream is heated by a plasma generator.

5. The process according to claim 1, wherein the gas stream is a hydrogen-containing gas stream or a gas stream consisting of hydrogen.

6. The process according to claim 1, wherein a silicon compound which is thermally decomposed at the gas temperature selected is added to the gas stream.

7. The process according to claim 1, wherein the gas stream is introduced into a reactor in which collecting and, optionally, condensing the liquid and/or gaseous silicon occurs.

8. The process according to claim 1, wherein collected liquid silicon is subjected to a vacuum treatment before cooling.

9. The process according to claim 1, wherein collected liquid silicon is subjected to directional solidification during cooling.

10. Silicon produced by the process according to claim 1.

11. The process according to claim 2, wherein the silicon-containing powder is subjected to a chemical and/or mechanical purification before being fed into the gas stream.

12. The process according to claim 1, wherein the gas stream is heated by a plasma generator.

13. The process according to claim 3, wherein the gas stream is heated by a plasma generator.

14. The process according to claim 2, wherein the gas stream is a hydrogen-containing gas stream or a gas stream consisting of hydrogen.

15. The process according to claim 3, wherein the gas stream is a hydrogen-containing gas stream or a gas stream consisting of hydrogen.

16. The process according to claim 4, wherein the gas stream is a hydrogen-containing gas stream or a gas stream consisting of hydrogen.

17. The process according to claim 2, wherein a silicon compound which is thermally decomposed at the gas temperature selected is added to the gas stream.

18. The process according to claim 3, wherein a silicon compound which is thermally decomposed at the gas temperature selected is added to the gas stream.

19. The process according to claim 4, wherein a silicon compound which is thermally decomposed at the gas temperature selected is added to the gas stream.

20. The process according to claim 5, wherein a silicon compound which is thermally decomposed at the gas temperature selected is added to the gas stream.
